(19) United States
(12) Patent Application Publication
(10) Pub. No.: US 2018/0126530 A1
(43) Pub. Date: May 10, 2018

(54) CONTROL SYSTEM FOR GAS SPRING FASTENER DRIVER

(71) Applicant: TTI (MACAO COMMERCIAL OFFSHORE) LIMITED, Macau (MO)

(72) Inventors: Edward Pomeroy, Piedmont, SC (US); Zachary Scott, Easley, SC (US); John Schnell, Anderson, SC (US); Essam Namouz, Greenville, SC (US)

(21) Appl. No.: 15/807,730

(22) Filed: Nov. 9, 2017

Related U.S. Application Data
(60) Provisional application No. 62/419,863, filed on Nov. 9, 2016.
(60) Provisional application No. 62/419,801, filed on Nov. 9, 2016.

(51) Int. Cl. B25C 1/04; B25C 1/06; B25C 1/00

(52) U.S. Cl. CPC B25C 1/047; B25C 1/008; B25C 1/06

(57) ABSTRACT

A fastener driver comprises a driver blade movable from a retracted position to an extended, driven position for driving a fastener into a workpiece, a gas spring mechanism for driving the driver blade from the retracted position to the driven position, the gas spring mechanism including a storage chamber cylinder containing a pressurized gas, means for determining a pressure in the storage cylinder chamber, and an indicator activated in response to the determined pressure in the storage cylinder chamber being less than a predetermined pressure value.

### CROSS-REFERENCE TO RELATED APPLICATIONS

This application claims priority to co-pending U.S. Provisional Patent Application Nos. 62/419,863 and 62/419,801, both filed on Nov. 9, 2016, the entire contents of which are incorporated herein by reference.

### FIELD OF THE INVENTION

The present invention relates to power tools, and more particularly to gas spring fastener drivers.

### BACKGROUND OF THE INVENTION

There are various fastener drivers used to drive fasteners (e.g., nails, tacks, staples, etc.) into a workpiece known in the art. These fastener drivers operate utilizing various means (e.g., compressed air generated by an air compressor, electrical energy, flywheel mechanisms) known in the art, but often these designs are met with power, size, and cost constraints.

### SUMMARY OF THE INVENTION

The present invention provides, in one aspect, a fastener driver comprising a driver blade movable from a retracted position to an extended, driven position for driving a fastener into a workpiece, a gas spring mechanism for driving the driver blade from the retracted position to the driven position, the gas spring mechanism including a storage chamber cylinder containing a pressurized gas, means for determining a pressure in the storage cylinder chamber, and an indicator activated in response to the determined pressure in the storage cylinder chamber being less than a predetermined pressure value.

The present invention provides, in another aspect, a method of operating a fastener driver. The method comprises initiating a fastener driving operation by moving a driver blade, with a gas spring mechanism, from a retracted position toward a driven position, determining a pressure of pressurized gas in a storage cylinder chamber of the gas spring mechanism, and indicating to a user of the fastener driver when the determined pressure in the storage chamber cylinder is less than a predetermined pressure value.

Other features and aspects of the invention will become apparent by consideration of the following detailed description and accompanying drawings.

### BRIEF DESCRIPTION OF THE DRAWINGS

FIG. 1 is a side view of a gas spring fastener driver in accordance with an embodiment of the invention

FIG. 2 is a cross-sectional view of the gas spring fastener driver of FIG. 1 along line 2-2 in FIG. 1.

FIG. 3 is a cross-sectional view of a portion of the gas spring fastener driver of FIG. 1 along line 3-3 in FIG. 2.

FIG. 4 is a schematic illustrating a control circuit of the gas spring fastener driver of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

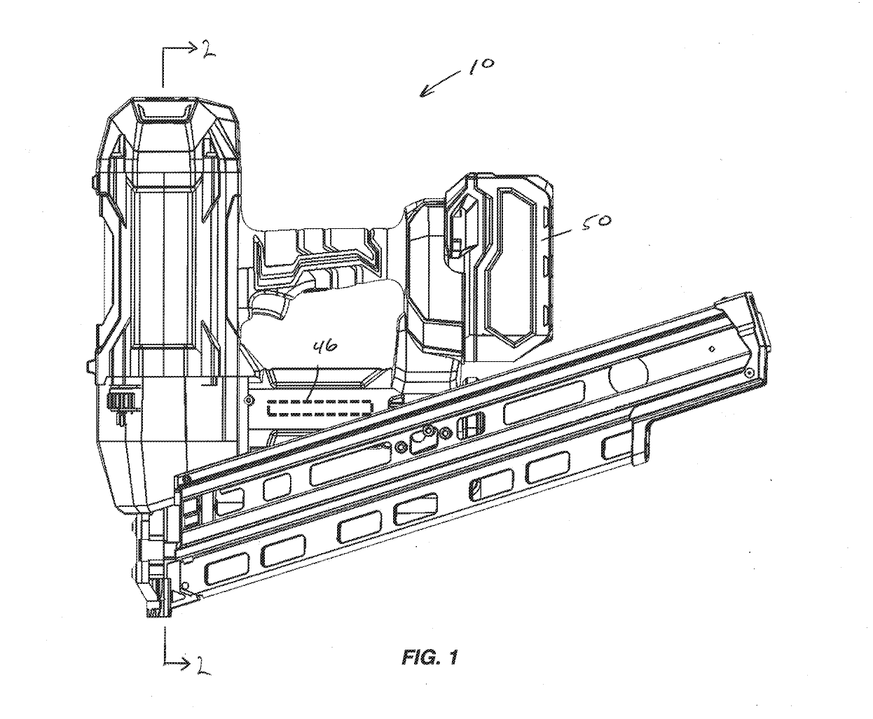

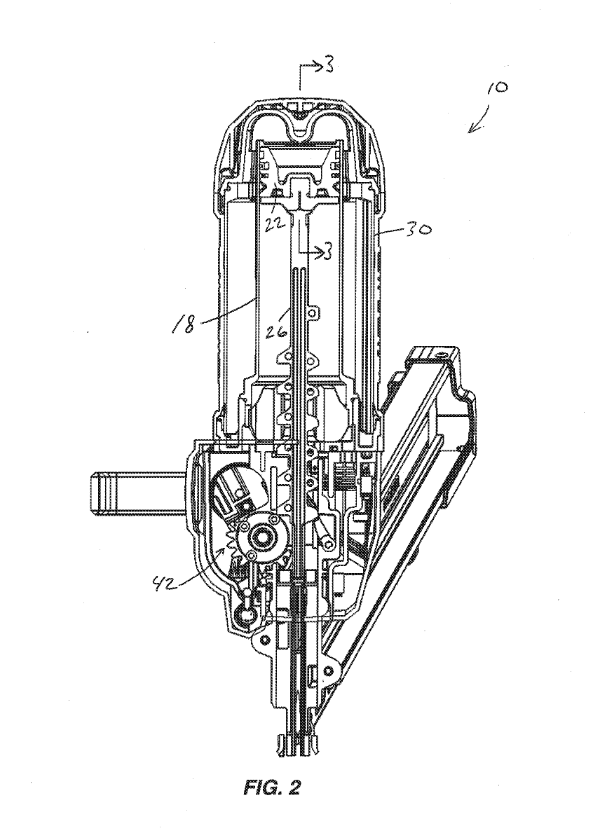

With reference to FIGS. 1 and 2, a gas spring-powered fastener driver 10 is operable to drive fasteners (e.g., nails, tacks, staples, etc.) held within a magazine (not shown) into a workpiece. The fastener driver 10 includes a cylinder 18 (FIG. 2) and a moveable drive piston 22 positioned within the cylinder 18. The fastener driver 10 also includes a driver blade 26 that is attached to the piston 22 for movement therewith. The fastener driver 10 does not require an external source of air pressure, but rather includes a storage chamber cylinder 30 of pressurized gas (e.g., compressed air) in fluid communication with a portion of the cylinder 18 above the drive piston 22. The portion of the cylinder 18 beneath the drive piston 22, however, is in fluid communication with ambient air at atmospheric pressure. In the illustrated embodiment, the cylinder 18 and driver piston 22 are positioned within and coaxial with the storage chamber cylinder 30.

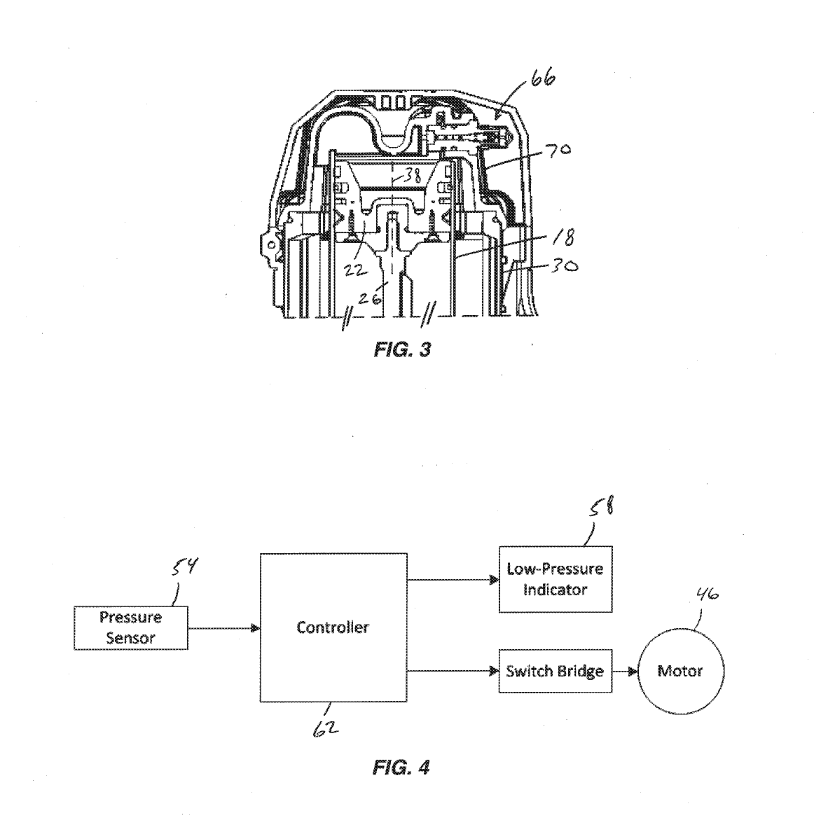

With reference to FIGS. 2 and 3, the cylinder 18 and the driver blade 26 define a driving axis 38, and during a driving cycle the driver blade 26 and piston 22 are moveable between a retracted position (e.g., a top dead center position within the cylinder 18) and an extended, driven position (e.g., a bottom dead center position within the cylinder 18). As shown in FIG. 2, the fastener driver 10 further includes a lifter assembly 42, which is powered by a motor 46 (FIGS. 1 and 4), and which is operable to return the driver blade 26 and piston 22 from the driven position to a ready (i.e., retracted) position. A battery 50 (FIG. 1) is electrically connectable to the motor 46 for supplying electrical power to the motor 46. In alternative embodiments, the driver may be powered from an AC voltage input (i.e., from a wall outlet).

In operation of the fastener driver 10, the lifter assembly 42 drives the piston 22 and the driver blade 26 to the retracted or ready position by energizing the motor 46. As the piston 22 and the driver blade 26 are driven to the ready position, the gas above the piston 22 and the gas within the storage chamber cylinder 30 is compressed. Once in the ready position, the piston 22 and the driver blade 26 are held in position until released by user activation of a trigger (FIG. 1). When released, the compressed gas above the piston 22 and within the storage chamber 30 drives the piston 22 and the driver blade 26 to the driven position, thereby driving a fastener into a workpiece.

As shown in FIG. 4, the fastener driver 10 includes a pressure sensor 54 (e.g., a pressure transducer or switch) to determine and/or detect the pressure of the compressed gas within the cylinders 18, 30 and a low-pressure indicator 58 (e.g., an LED) to alert the user of the fastener driver 10 of a low pressure condition in the cylinders 18, 30. More specifically, a controller 62 in the fastener driver 10 compares the output of the pressure sensor 54 to a predetermined threshold pressure, below which the controller 62 activates the indicator 58.

In some embodiments, the controller 62 may use other techniques to determine the pressure of the compressed gas in the cylinders 18, 30. For example, the controller 62 may monitor a current draw on the motor 46 when operating the lifter assembly 42 to return the driver blade 26 and piston 22 to the ready position which, using an algorithm, can be interpolated to pressure in the cylinders 18, 30. When the controller 62 determines that the current (and/or power) draw on the motor 46 is below a predetermined threshold indicating that the pressure of compressed gas in the cylinders 18, 30 has fallen below a predetermined pressure threshold, the controller 62 may activate the low-pressure indicator 58 to provide a low-pressure alert to the user. In other words, the controller 62 is operable to correlate the current, voltage, and/or power, consumed by the motor 46 to a corresponding pressure value within the cylinders 18, 30.

With reference to FIG. 3, the fastener driver 10 further includes a fill valve 66 coupled to an end cap 70 of the storage chamber cylinder 30. The fill valve 66 is configured to be selectively connected with a gas fitting (not shown) which, in turn, is fluidly connected with a source of compressed gas (e.g., an air compressor, etc.). When connected with the source of compressed gas via the gas fitting, the fill valve 66 permits the storage chamber cylinder 30 to be refilled or recharged with compressed gas if prior leakage has occurred, as communicated to the user by activation of the low-pressure indicator 58. The storage chamber cylinder 30 may be filled to a desired pressure between approximately 90 psi and approximately 150 psi (e.g., approximately 120 psi). In some embodiments, the pressure may be less than 100 psi and greater than 150 psi. In some embodiments, the fill valve 66 may be configured as a Schrader valve. In other embodiments, the fill valve 66 is configured as a Presta valve, Dunlop valve, or other similar pneumatic fill valve. The fill valve 66 also allows a user to measure and check the pressure within the storage chamber cylinder 30 with any standard pressure gauge device.

Various features of the invention are set forth in the following claims.

What is claimed is:

1. A fastener driver comprising:
a driver blade movable from a retracted position to an extended, driven position for driving a fastener into a workpiece;
a gas spring mechanism for driving the driver blade from the retracted position to the driven position, the gas spring mechanism including a storage chamber cylinder containing a pressurized gas;
means for determining a pressure in the storage cylinder chamber; and
an indicator activated in response to the determined pressure in the storage cylinder chamber being less than a predetermined pressure value.

2. The fastener driver of claim 1, wherein the pressure determining means includes a pressure sensor or a pressure switch.

3. The fastener driver of claim 2, wherein the pressure sensor is in fluid communication with the storage chamber cylinder to detect the pressure of the pressurized gas therein.

4. The fastener driver of claim 3, further comprising a controller to which both the pressure sensor and the indicator are electrically connected.

5. The fastener driver of claim 4, wherein the pressure sensor outputs a signal to the controller that is proportional to the pressure of the pressurized gas in the storage chamber cylinder.

6. The fastener driver of claim 5, wherein the signal is a variable voltage signal.

7. The fastener driver of claim 5, wherein the controller interpolates the signal into a measured pressure value, and wherein the controller includes a comparator that compares the measured pressure value to the predetermined pressure value.

8. The fastener driver of claim 7, wherein the controller activates the indicator in response to the measured pressure value being less than the predetermined pressure value.

9. The fastener driver of claim 1, wherein the indicator is a light-emitting diode.

10. The fastener driver of claim 1, further comprising
a lifter mechanism for moving the driver blade from the driven position toward the retracted position, the lifter mechanism including a motor, and
a controller electrically connected with the motor to monitor a current draw thereof,
wherein the pressure determining means includes an algorithm stored in the controller for converting the current draw into the determined pressure in the storage chamber cylinder.

11. A method of operating a fastener driver, the method comprising:
initiating a fastener driving operation by moving a driver blade, with a gas spring mechanism, from a retracted position toward a driven position;
determining a pressure of pressurized gas in a storage cylinder chamber of the gas spring mechanism; and
indicating to a user of the fastener driver when the determined pressure in the storage chamber cylinder is less than a predetermined pressure value.

12. The method of claim 11, wherein the pressure of the pressurized gas is determined by a pressure sensor or a pressure switch.

13. The method of claim 12, further comprising outputting a signal from the pressure sensor to a controller that is proportional to the pressure of the pressurized gas in the storage chamber cylinder.

14. The method of claim 13, further comprising interpolating the signal, with the controller, into a measured pressure value.

15. The method of claim 14, further comprising comparing the measured pressure value, with the controller, to the predetermined pressure value.

16. The method of claim 15, wherein indicating to the user of the fastener driver when the measured pressure value in the storage chamber cylinder is less than the predetermined pressure value includes activating a light-emitting diode.

17. The method of claim 11, wherein the pressure of the pressurized gas is determined by monitoring a current draw of a motor, which is operable to move the driver blade from the driven position toward the retracted position.

18. The method of claim 17, further comprising converting the current draw into a measured pressure value in the storage chamber cylinder using an algorithm stored in the controller.

19. The method of claim 18, further comprising comparing the measured pressure value, with the controller, to the predetermined pressure value.

20. The method of claim 19, wherein indicating to the user of the fastener driver when the measured pressure value in the storage chamber cylinder is less than a predetermined pressure value includes activating a light-emitting diode.
